(19) United States
(12) Patent Application Publication
(10) Pub. No.: US 2012/0081894 A1
(43) Pub. Date: Apr. 5, 2012

(54) INCANDESCENT LED REPLACEMENT LAMP

(75) Inventors: David L. SIMON, Grosse Pointe Woods, MI (US); John IVEY, Farmington Hills, MI (US); Gordon LAVERING, Belmont, CA (US)

(73) Assignee: ALTAIR ENGINEERING, INC., Troy, MI (US)

(21) Appl. No.: 13/242,609

(22) Filed: Sep. 23, 2011

Related U.S. Application Data
(60) Provisional application No. 61/388,101, filed on Sep. 30, 2010.

(51) Int. Cl. F21V 29/00; F21V 13/04; F21V 7/04

(52) U.S. Cl. 362/235; 362/249.02

(57) ABSTRACT

An LED-based lamp comprises a contact base, an LED support plate, a circuit board supported by the LED support plate, LEDs mounted to the circuit board, a heat transferring structure, a heat dissipating structure, a reflector and a bulb cover enclosing the circuit board, the LEDs, the LED support plate and the reflector. The LED support plate and the heat dissipating structure each dissipate a portion of the heat generated by LEDs. The heat transferring structure thermally couples the LED support plate to the heat dissipating structure and distributes the heat dissipation between them. The LEDs are oriented to project light in a first direction along a vertical axis of the LED-based lamp. A reflector is positioned in the first direction to diffuse light from the LEDs such that a majority portion of the light is directed in a second direction away from the first direction.

### CROSS REFERENCE TO RELATED APPLICATION

This application claims priority to U.S. Provisional Patent Application No. 61/388,101, filed Sep. 30, 2010, which is incorporated herein by reference in its entirety.

### TECHNICAL FIELD

The invention relates to a light emitting diode (LED) based light, for example, an LED-based light usable in an Edison-type fixture in place of a conventional incandescent bulb.

### BACKGROUND

Incandescent light bulbs are commonly used in many environments, such as households, commercial buildings, and advertisement lighting, and are used in many types of fixtures, such as desk lamps and overhead fixtures. Incandescent bulbs commonly have a threaded electrical connector for use in Edison-type fixtures, though incandescent bulbs can include other types of electrical connectors such as a bayonet connector or pin connector. Incandescent light bulbs generally consume large amounts of energy and have short life-spans. Indeed, many countries have begun phasing out or plan to phase out the use of incandescent light bulbs entirely.

Compact fluorescent light bulbs (CFLs) are gaining popularity as replacements for incandescent light bulbs. CFLs are typically much more energy efficient than incandescent light bulbs, and CFLs typically have much longer life-spans than incandescent light bulbs. However, there are several drawbacks of using CFLs. First, CFLs contain mercury, a toxic chemical, which makes the disposal of CFLs difficult. Second, CFLs require a momentary start-up period before producing light. Third, many consumers do not find CFLs able to produce light of similar quality as incandescent bulbs. And finally, CFLs are often larger than incandescent lights of similar luminosity, and some consumers find CFLs unsightly when not lit.

### SUMMARY

The invention relates, in one embodiment, to an LED-based lamp for use in a standard light fixture. The LED based lamp comprises a contact base, at least one LED, an LED support, a heat dissipating structure and a heat transferring structure. The contact base has a connector to provide a physical connection to a standard light fixture. The LED support plate is thermally coupled to the at least one LED and is configured to conduct heat generated by the at least one LED and to dissipate a first portion of the heat generated by the at least one LED. The heat dissipating structure is configured to dissipate a second portion of the heat generated by the at least one LED to the ambient air. The heat transferring structure is provided to thermally couple the LED support plate to the heat dissipating structure and to distribute heat dissipation between the LED support plate and the heat dissipating structure. In one aspect of this embodiment, the LED-based lamp further comprises a bulb cover. The bulb cover encloses the LED support plate and the at least one LED and is configured to dissipate heat from the LED support plate to the ambient air.

The invention relates, in another embodiment, to an LED-based lamp for use in a standard light fixture comprising a contact base, at least one LED, a reflector and a bulb cover. The contact base has a connector to provide a physical connection to a standard light fixture. The at least one LED is oriented to project light in a first direction along a vertical axis of the LED-based lamp. The reflector is positioned adjacent to the at least one LED in the first direction and is configured to diffuse the light from the at least one LED such that a majority portion of the light is directed in a second direction away from the first direction. The bulb cover is provided to enclose the at least one LED and the reflector.

The invention relates, in another embodiment, to an LED-based lamp for use in a standard light fixture. The LED based lamp comprises a contact base, at least one LED, an LED support plate, a bulb cover, a heat dissipating structure and a heat transferring structure. The contact base has a connector to provide a physical connection to a standard light fixture. The at least one LED is configured to provide luminosity similar to a conventional incandescent light bulb. The LED support plate is composed of a thermally conductive material and is configured to dissipate a first portion of the heat generated by the at least one LED. A bulb cover encloses the at least one LED and the LED support plate such that the first portion of the heat generated by the at least one LED is transferred to the bulb cover by radiation and convection for dissipation to the ambient air. The heat dissipating structure is composed of a thermally conductive material and is configured to dissipate a second portion of the heat generated by the at least one LED to the ambient air. The heat transferring structure is composed of a thermally conductive material, and connects the LED support plate to the heat dissipating structure in thermally conductive relation. The heat transferring structure distributes heat dissipation between the LED support plate and the heat dissipating structure to maintain the heat dissipating structure and an outer surface of the bulb cover at a temperature below 70° C.

### BRIEF DESCRIPTION OF THE DRAWINGS

The description herein makes reference to the accompanying drawings wherein like reference numerals refer to like parts throughout the several views, and wherein:

FIG. 1 is a perspective view of an LED replacement lamp according to one embodiment of the present invention;

FIG. 2 is a cross-sectional view of the LED replacement lamp of FIG. 1 taken along the line 2-2;

FIG. 3 is cross-sectional view of the LED replacement lamp of the LED replacement lamp of FIG. 1 taken along the line 3-3;

FIGS. 4A and 4B are perspective views of a reflector of the LED replacement lamp of FIG. 1;

FIGS. 5A and 5B are perspective views of a heat transferring structure of the LED replacement lamp of FIG. 1; and

FIG. 6 is a perspective view of a reflector according to another embodiment of the invention.

### DETAILED DESCRIPTION

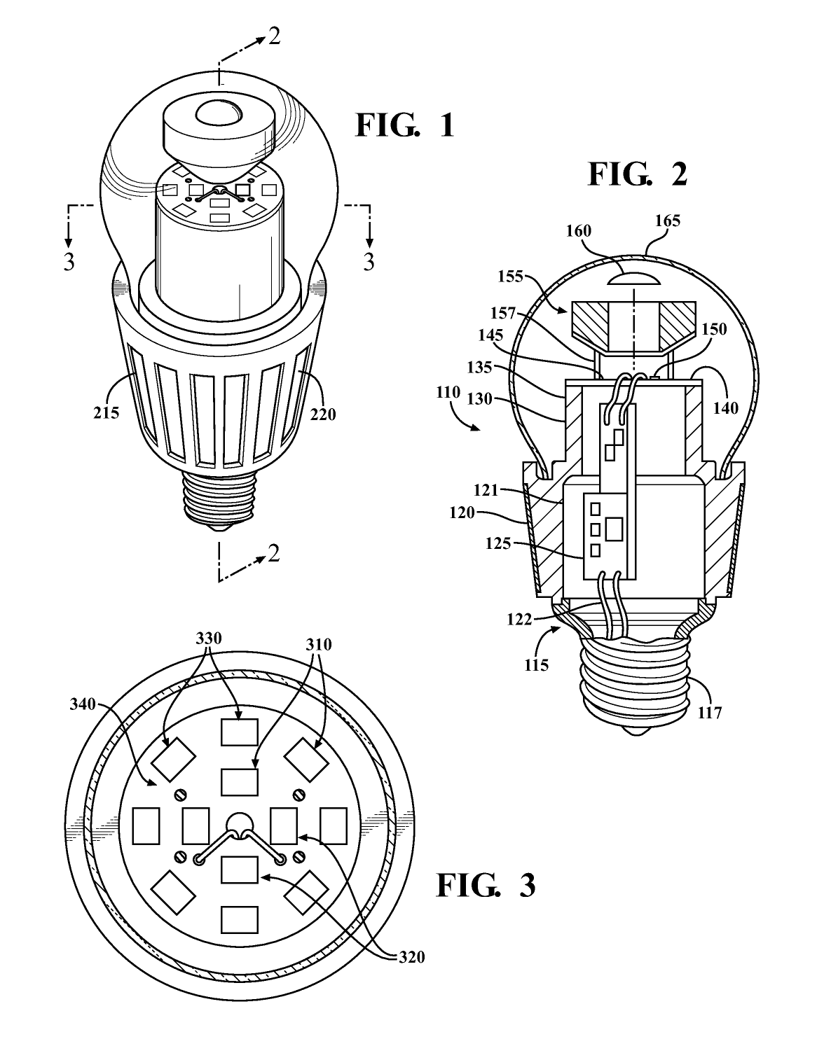

The present invention pertains to an LED replacement lamp. Embodiments of the LED replacement lamp are described herein with reference to FIGS. 1-6. However, those skilled in the art will readily appreciate that the detailed description contained herein with respect to FIGS. 1-6 is for explanatory purposes as the invention extends beyond these limited embodiments. The LED replacement lamp of the present invention can be used to replace a conventional incandescent light bulb in a conventional fixture, such as an Edison-type fixture.

FIG. 1 is a perspective view of an LED replacement lamp according to one embodiment of the present invention. The LED replacement lamp 110 according to the one embodiment can replace a conventional incandescent light bulb in a conventional fixture such as an Edison-type fixture. Alternatively, the LED replacement lamp 110 can be configured to replace another type of replacement lamp, for example a CFL replacement bulb. The improved LED replacement lamp 110 includes a contact base 115 for making contact with a conventional fixture (e.g. Edison-type fixture), a heat dissipating structure 120 having a cavity to house electronics 125 and connecting to the contact base 115, a LED support plate 135 that supports a LED circuit board 140, a heat transferring structure 130 that connects the heat dissipating structure 120 with the LED support plate 135, a plurality of LEDs 145 that are connected to the LED circuit board 140 and oriented upwardly along a vertical axis of the LED replacement lamp 110, and a reflector 155. The reflector 155 can diffuse the light beam from the LEDs 145 such that a major portion of the upwardly-projected light beam from the LEDs 145 is reflected downwardly and less than a majority portion of the upwardly-projected light beam from the LEDs 145 is allowed to project upwardly. A bulb cover 165 is connected to the heat dissipating structure 120 and can enclose, among other structures, the heat transferring structure 130, the LED support plate 135, the LEDs 145, the LED circuit board 140 and the reflector 155.

In one embodiment, as illustrated in FIGS. 1-5, the LED replacement lamp 110 includes a contact base 115. The contact base 115 can have a connector 117. The connector 117, as illustrated in FIG. 1, is preferably of an Edison-type connector. Without limiting the use of other types of connectors, the connector 117 can also be a bi-pin, bayonet-type connector, or another connector that is compatible with a conventional light fixture. And without limiting the generality of the foregoing, the type of connector 117 can also depend on the types of fixture with which the LED replacement lamp 110 is designed to be engaged. According to the illustrated embodiment, as illustrated in FIG. 1, the contact base 115, having the connector 117, is electrically connected to electronics 125. Without limiting the method of electrical connection, electrically conductive wires 122 can be used to link the connector 117 with the electronics 125. For example, the connector 117 can be snap-fitted, adhered, or otherwise fixed to a remainder of the contact base 115. The connector 117 can also be embedded within the contact base 115. For example, the contact base 115 can be constructed from a highly electrically conductive material, such as aluminum, another metal, or a highly electrically conductive polymer. In addition to providing an electrical connection between the LED replacement lamp 110 and the fixture, the connector 117 can also serve to physically connect the LED replacement lamp 110 to the fixture. By way of an example, by screwing the contact base 115 having the connector 117 into engagement with an Edison-type fixture, the LED replacement lamp 110 can be both physically and electrically connected to the fixture.

In one embodiment, as illustrated in FIGS. 1-5, the LED replacement lamp 110 further includes a heat dissipating structure 120 configured to dissipate the heat generated by the LEDs 145 to the ambient air. The heat dissipating structure 120 can further include a cavity to house electronics 125. The heat dissipating structure 120 can be hollow so as to define a compartment 121 large enough to house electronics 125. In one embodiment, the electronics 125 can be power conversion electronics. For example, the power conversion electronics can be a rectifier, a filtering capacitor, or DC to DC conversion circuitry. According to another embodiment, the electronics 125 can modify the input power that is received from the electrical connector 117, wherein an input power wave form is converted to an output power wave form suitable for powering the LED circuit board 140. By way of an example, the electronics 125 can convert AC to DC, which, according to the illustrated embodiment, is preferable for powering the LED circuit board 140. According to the illustrated embodiment, one end of the heat dissipating structure 120 is physically connected to the contact base 115. Without limiting the use of other types of physical connection, the heat dissipating structure 120 can be snap-fitted, adhered, or otherwise fixed to the contact base 115. Further according to the illustrated embodiment, as illustrated in FIGS. 1 and 2, the heat dissipating structure 120 can further include various apertures 215 along the wall of the heat dissipating structure 120. Each aperture 215 can provide a path of airflow between the compartment 121 and the ambient air external to the LED replacement lamp 110. As a result, the apertures 215 can allow airflow between the compartment 121 and the ambient air external to the LED replacement lamp 110, thereby facilitating the convective heat transfer from the heat dissipating structure 120 and the inside of the compartment 121 to the ambient air. Further according to the illustrated embodiment, the heat dissipating structure 120 can also include cooling fins 220. In one embodiment the cooling fins 220 are physically connect directly to the heat dissipating structure 120. Without limiting the types of physical connection, the cooling fins 220 can be snap-fitted, adhered, or otherwise fixed to the heat dissipating structure 120. In another one embodiment, the cooling fins 220 can be formed as a part of the heat dissipating structure 120. For example, the heat dissipating structure 120 and the cooling fins 220 can be constructed out of a thermally conductive material, such as a molded aluminum piece, or another type of metal or a highly thermally conductive polymer. In one embodiment, the cooling fins 220 can be wide, as illustrated in FIG. 2. In another embodiment, the cooling fins 220 can be narrow.

In one embodiment, as illustrated in FIGS. 1-5, the LED replacement lamp 110 further includes a heat transferring structure 130 and a LED support plate 135. The heat transferring structure 130 thermally couples the heat dissipating structure 120 and the LED support plate 135. According to the illustrated embodiment, a first end of the heat transferring structure 130 can be physically connected in thermally conductive relation to the heat dissipating structure 120, with an opposing second end connected in thermally conductive relation to the LED support plate 135. Without limiting the use of other types of physical connection, the heat transferring structure 130 can be snap-fitted, adhered, or otherwise fixed to the heat dissipating structure 120 or the LED support plate 135, respectively. The heat transferring structure 130 and the LED support plate 135 can be constructed from a thermally conductive material, such as a molded aluminum piece, or another type of metal or a highly thermally conductive polymer.

A sufficient amount of the heat generated by the LEDs 145 must be dissipated to the ambient air in order to ensure the intended operation of the LEDs 145, such that the LEDs 145 can produce a sufficient amount of light to replace an incandescent bulb, such as a 60 W or a 100 W incandescent bulb. In the LED replacement lamp 110, the heat from the LEDs 145 is primarily dissipated to the ambient air through the heat dissipating structure 120 and the LED support plate 135. A portion of the heat is conducted through the heat transferring structure 130 to the heat dissipating structure 120, which dissipates the heat to the ambient air by radiation and free convection. A portion of the heat is also transferred from the LED support plate 135 by radiation and free convection to the bulb cover 165, and is ultimately transferred to the ambient air from the outer surface of the bulb cover 165. Because the heat dissipating structure 120 and the bulb cover 165 are touchable surfaces, it is desirable to control their respective temperatures while still maintaining a sufficient amount of heat dissipation to the ambient air to allow proper operation of the LEDs 145.

In one aspect of the LED replacement lamp 110, area enhancement can useful maintaining a cool touchable surface of the LED replacement lamp 110. For example, if the surface area of the bulb cover 165 is large in comparison to the area of the LED support plate 135 from which heat is transferred bulb cover 165, the temperature of the outer surface of the bulb cover 165 can be lower than the temperature of the LED support plate. Because the power density of the bulb cover 165 is lower that that of the LED support plate 135, the outer surface of the bulb cover 165 will feel cooler to the touch compared to the surface of the LEDs.

In another aspect of the LED replacement lamp 110, the heat transferring structure 130 can form a heat dam that optimally distributes the heat dissipation between the LED support plate 135 and the heat dissipating structure 120. For example, by distributing heat dissipation to the heat dissipating structure 120, and away from the LED support plate 135, the temperature of the bulb cover 165 can be lowered, making the touchable surface of the bulb cover 165 cooler to the touch. By distributing heat dissipation to the LED support plate 135, and away from the heat dissipating structure 120, the touchable surface of the heat dissipating structure 120 can be reduced.

As illustrated in FIGS. 1, 2 and 6, the heat transferring structure 210 can be constructed in the shape of a cylindrical tube 605 defined by an inner radius 610, an outer radius 615 and a height 620, where a cylindrical tube wall 625 is defined by the difference between the outer radius 615 and the inner radius 610. The cylindrical tube 605 from which the heat transferring structure 210 can be constructed can be further defined, by way of an example, by a top inner radius 630, a top outer radius 635, a bottom inner radius 640, a bottom outer radius 645 and a height 620, where the top inner radius 630 is not equal to the bottom inner radius 640, and the top outer radius 635 is not equal to the bottom outer radius 645, such that the cylindrical tube wall 625 is tapered along the height of the cylindrical tube. The cylindrical tube 605 from which the heat transferring structure 210 can be constructed can be further defined, by way of another example, by a variable inner radius, a variable outer radius, and a height, where the cylindrical tube wall 625 has variable thickness along the height of the cylindrical tube 605, which can depend on the variable inner radius and variable outer radius measured at a point along the height of the cylindrical tube 605. Without limiting the types of structure from which the heat transferring structure 210 can be constructed, the heat transferring structure 210 can also be constructed from a solid cylinder defined by a constant or a variable radius and a height, a rectangular or square tube with constant or variable tube wall thickness, or any other structure that can be configured to transfer a sufficient amount of heat for operation of the LEDs 145 at a specified power level, while maintaining the touchable surfaces of the heat dissipating structure 120 and the bulb cover 165 at safe temperatures.

In one embodiment, the heat transferring structure 210 can be constructed from a thermally conductive material, such as aluminum, another metal, or a highly thermally conductive polymer. In another embodiment, the heat transferring structure 210, the heat dissipating structure 120 and the contact base 115 can, individually or in combination, be constructed out of a molded aluminum piece, or another type of metal or a highly thermally conductive polymer. The desired configuration of the heat transferring structure 210 for a particular application of the LED replacement lamp 110 can be determined by using fluid dynamics software, hand calculation, experimentation, or using other methods familiar to those skilled in the art. In the example of an LED replacement lamp 110 illustrated in FIGS. 1, 2 and 6, heat transferring structure 130, 210, the heat dissipating structure 120 and the LED support plate 135 are aluminum, and the heat transferring structure 130, 210 is configured to provide a heat dissipation distribution of 15% to the LED support plate 135 and 85% to the heat dissipating structure 120. With the LED replacement lamp 110 operating at a 10 W power output in 25° C. ambient air, the operating temperature of the LEDs 145, as measured on the surface of the LED support plate 135, is 97° C., while the touchable surfaces of the heat dissipating structure 120 and the bulb cover 165 are each maintained at a temperature below 70° C.

In one embodiment, as illustrated in FIGS. 1-5, an LED replacement lamp 110 further includes a LED circuit board 140. The LEDs 145 are mounted to the circuit board 140, and the circuit board 140 provides a heat transfer path between the LEDs 145 and the LED support plate 135. The LED circuit board 140 is supported by and physically connected to the LED support plate 135. Without limiting the use of other types of physical connection, the LED circuit board 140 can be snap-fitted, adhered, or otherwise fixed to the LED support plate 135. In one embodiment, the LED support plate 135 and the LED circuit 140 are incorporated in one unified structure. According to the illustrated embodiment, as illustrated in FIG. 3, the LED circuit board 140 is an annular printed circuit board. Without limiting the shape of the LED circuit board 140, the LED circuit board 140 can also be in the shapes of square, rectangle, or any shape that can be supported by the LED support plate 135. In one embodiment, the LED circuit board 140 can be formed from multiple circuit board sections, which can be electronically connected to one another using, for example, bridge connectors, wires or any suitable electrical connection method. By way of an example, the LED circuit board 140 can be formed from multiple rectangular circuit boards arranged about the LED support plate 135. Without limiting the types of circuit board used in constructing the LED circuit board 140, instead of using a printed circuit board, other types of circuit boards can also be used, such as a metal core circuit board. In one embodiment, instead of using a LED circuit board 140, other types of electrical connections (e.g., wires) can be used to electrically connect individual LEDs 145 to one another and/or the electronics 125. In one embodiment, the LED support plate 135, the heat transferring structure 130, the heat dissipating structure 120 and the contact base 115 can, individually or in combination, be constructed out of a molded aluminum piece, or another type of metal or a highly thermally conductive polymer.

In one embodiment, as illustrated in FIG. 1, an LED replacement lamp 110 further includes a plurality of LEDs 150. Further according to the illustrated embodiment, as illustrated in FIG. 3, the LEDs 310 can be mounted on the LED circuit board 340 and be in electrical communication therewith. The LEDs 310 can be further arranged in an annular configuration with inner circle LEDs 320 and outer circle LEDs 330. The inner circle LEDs 320 can be arranged in an equally spaced configuration that is centered around a first pitch circle with an inner pitch circle radius. The outer circle LEDs 330 can be arranged in an equally spaced configuration that is centered around a second pitch circle with an outer pitch circle radius. In one embodiment, the inner pitch circle and the outer pitch circle are concentric to one another. In one embodiment, by way of an example and without limiting the placement of LEDs 310 on the LED circuit board 340, the inner circle LEDs 320 can include four LEDs, equally spaced and centered on a pitch circle, preferably of 0.55 inch in radius, and the outer circle LEDs 330 can include eight LEDs 310, equally spaced and centered on another pitch circle, preferably of 1.04 inch in radius. In one embodiment, the LEDs 310 can be arranged spaced on centered on a pitch circle, and other LEDs 310 can be arranged on a perimeter surface perpendicular to the surface on which the first LEDs are arranged. In another embodiment, the LEDs 310 can be arranged in another fashion, such as using different numbers of LEDs for inner and outer circle, using different pitch circle radiuses for the inner and outer pitch circles, using only a single circle of LEDs, adding additional circles of LEDs having different pitch circle radiuses, or arranging the LEDs in a pattern of one or more concentric squares or rectangles having different lengths and/or widths. In one embodiment, The LEDs 310 can be surface-mounted devices of a type available from Nichia, although other types of LEDs can alternately be used. Although surface-mounted LEDs 310 are shown, according to the illustrated embodiment, one or more organic LEDs can be used in place of or in addition to the surface-mounted LEDs. In one embodiment, each LED 310 can include a single diode or multiple diodes, such as a package of diodes producing light that appears to an ordinary observer as having been produced from a single light source. In one embodiment and without limiting other types of physical or electrical connections, the LEDs 310 can be mounted on and be electrically connected to the LED circuit board 340 using, for example, solder (with or without lead), electrically conductive adhesive, or another type of connection. In one embodiment, the LEDs 310 can emit white light. However, LEDs that can emit blue light, ultra-violet light or light of other wavelength can also be used in place of LEDs that can emit white light.

As illustrated in FIG. 1, the number and power level of the LEDs 145 can be selected such that the improved LED replacement lamp 110 can produce a similar amount of luminosity as a conventional incandescent bulb that the improved LED replacement lamp 110 is intended to be a substitute for. It is understood that a person skilled in the art will readily appreciate that different numbers of LEDs and, thus, different power output is required for the LEDs to produce a similar amount of luminosity as a conventional incandescent bulb or any other types of bulb the improved LED replacement lamp 110 is intended to be a substitute for. By way of an example, if the improved LED replacement lamp 110 is intended as substitute for a 60 Watt incandescent bulb, the LEDs 145, in the aggregate, can require 8-15 Watt of power, although this power level may change as LED technology improves. However, if the improved LED replacement lamp 110 is intended to replicate another type of bulb, the LEDs 145 can configured to output a different amount of light. In addition, although FIG. 1 shows a plurality of LEDs 145, the LED replacement lamp 110 can have a single LED.

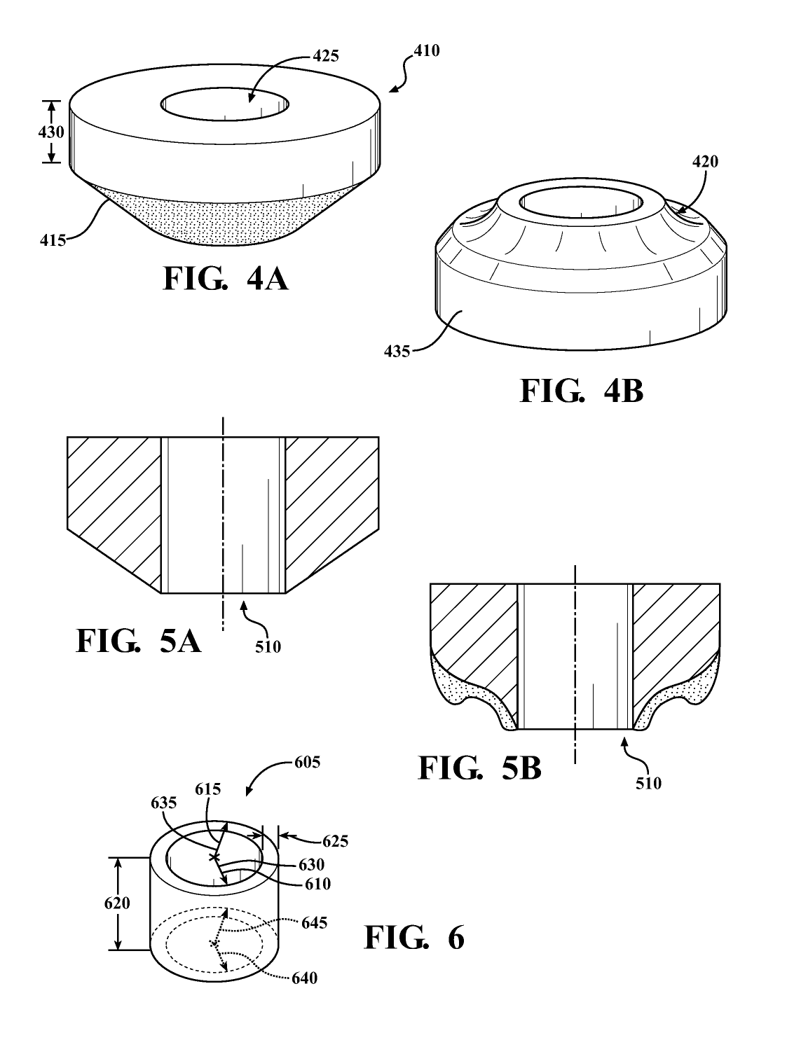

In one embodiment, as illustrated in FIGS. 1 and 2, the LED replacement lamp 110 further includes a reflector 155 adjacent to the LEDs 145. In one embodiment, the reflector 155 can be mounted on four reflector stilts 157 that are connected directly to the LED support plate 135. Without limiting the use of other types of physical connection and configuration, the reflector 155 and the reflector stilts 157 can be snap-fitted, adhered, or otherwise fixed to the LED support plate 135, the heat transferring structure 130, the heat dissipating structure 120, or the contact base 115, respectively. In another embodiment, the reflector 155 can be mounted on any configuration of stilts, supporting rods, or other supporting structure such that the reflector can be positioned above the LEDs 145. In one embodiment, the reflector 155 can be formed from multiple reflector sections, which can be connected to one another physically, electrically or optically. This can be achieved using, for example, bridge connectors, wires, or any suitable electrical connection method with respect to any electrical connection; snap-fit, adherence, or any suitable physical connection method to connect the multiple reflector sections with respect to any physical connection; optical bridge, connection tunnels, or any other suitable optical connection methods with respect to any optical connection. In addition, in order to improve the light beam distribution, according to one embodiment, the reflector 155 can be used to diffuse the light beam from the LEDs 145 such that a major portion of the upwardly-projected light beam from the LEDs 145 is reflected downwardly with respect to the vertical axis of the LED replacement lamp 110, and less than a majority portion of the upwardly-projected light beam from the LEDs 145 is allowed to project upwardly. Further according to the illustrated embodiment, as illustrated in FIGS. 4A, 4B, 5A and 5B, the reflector 410 is shaped as an invertedly positioned cone with an aperture 425 defined by a reflector surface 415, which can be a conic surface generated by a straight line passing through a vertex and moving along a fixed closed curve, a plane generated by the fixed closed curve, a reflector base 435 defined by the plane generated by the fixed closed curve and a base height 430, and an aperture 425 with an aperture radius 510, in which the aperture 425 creates a cylindrical hollow through the reflector 410. In another embodiment the reflector 410 can be a solid cone with an aperture 425 defined by a plane base bounded by a closed curve (e.g. circle or ellipse), where every point of which is joined to a fixed point lies outside the plane of the base, a reflector base 435 defined by the closed curve of the plane base and an aperture with an aperture radius 510, such that the aperture 425 creates a cylindrical hollow through the invertedly positioned solid cone. In yet another embodiment and without limiting the generality of the foregoing, the reflector surface 415 can also be a non-conic surface 420 such as, for example, arcuate, bevel or any other shaped surface that can be configured to optimize the light beam distribution. Another example of a reflector 410 with an aperture can be donut shaped. A major portion of the upwards-projected LED light can be reflected downwards to illuminate the 90°/150° zone whereas a lesser portion can be allowed to project upwards and through the aperture. The upwards-projected light rays may be further re-distributed by the use of a beam spread lens 160 or a graded diffusive surface on the inner surface of the bulb cover 165. Beam distribution can be further enhanced by mounting a double-coned lens over one or more of the plurality of LEDs. A double-domed lens can also be used over one or more of the LEDs. Although the light beam from the LEDs 145 is described as projecting upwards and being reflected downwards in accordance with the illustrated embodiment, it should be understood that the orientation of the LED replacement lamp 110 will vary depending on the application. For example, the LED replacement lamp 110 could be oriented such that a major portion of a downwardly-projected light beam from the LEDs 145 is reflected upwardly, while less than a majority portion of the downwardly-projected light beam from the LEDs 145 is allowed to project downwardly. By further example, the LED replacement lamp 110 could be oriented such that the LEDs 145 are oriented to project a light beam in a first direction along a vertical axis of the LED replacement light 110. The reflector 155 can be used to diffuse the light beam such that a majority portion of the light is directed in a second direction away from the first direction and less than a majority portion of the light beam from the LEDs 145 is allowed to project in the first direction.

In one embodiment, as illustrated in FIG. 1, an LED replacement lamp 110 further includes a bulb cover 165. The bulb cover 165 is connected with the heat dissipating structure 120 and can enclose the heat transferring structure 130, the LED support plate 135, the LEDs 145, the LED circuit board 140 and the reflector 155. Without limiting the use of other types of physical connection, the bulb cover 165 can be snap-fitted, adhered, or otherwise fixed to the heat dissipating structure 120, heat transferring structure 130, LED support plate 135, or contact base 115. Additionally, the bulb cover 165 can be clear, frosted, opaque, colored or any other type of bulb surface that can be used on an incandescent bulb.

In another embodiment, as illustrated in FIG. 1, the LED replacement lamp 110 of the first embodiment further includes a plurality of LED lens/dust caps 150. In one embodiment, the plurality of LED lens/dust caps 150 are connected to the LEDs 145 and are shaped to achieve an optimal beam spread. Without limiting the type of connection between the plurality of LED lens/dust caps 150 and the LEDs 145, the plurality of LED lens/dust caps 150 can be bonded, adhered, or otherwise attached to the LEDs 145. In another embodiment, the plurality of LED lens/dust caps 150 can have flat, domed or other configured surface, such as a lens/dust cap having a drilled out portion defined by a critical angle required to cause maximum deflection of the axial LED light rays emitted from the LEDs 145. For example, beam distribution can be further enhanced by mounting a double-coned lens over one or more of the plurality of LEDs. A double-domed lens can also be used over one or more of the LEDs. Without limiting other configurations of the plurality of lens/dust caps 150, the critical angle can also be determined using empirical methods by viewing and adjusting the critical angle such that the LEDs 145 can achieve an optimal beam spread. For example, beam distribution can be further enhanced by mounting a double-coned lens over one or more of the plurality of LEDs. A double-domed lens can also be used over one or more of the LEDs. According to the another embodiment, the bulb cover 165 can enclose the heat transferring structure 130, the LED support plate 135, the LEDs 145, the LED circuit board 140, the plurality of LED lens/dust caps 150 and the reflector 155.

According to yet another embodiment, as illustrated in FIG. 1, the improved LED replacement 110 of the first embodiment can be further configured to include a beam spread lens 160 that can be further configured to spread the upwardly-projected light beam emitted from the LEDs 145. In one embodiment, the beam spread lens 160 is connected with the reflector 155. Without limiting the type of connection between the beam spread lens 160 and the reflector 155, the beam spread lens 160 can be snapped-on, adhered, or otherwise attached to the reflector 155. In another embodiment and without limiting the generality of the foregoing, the beam spread lens 160 can also be mounted on any configuration of stilts, supporting rods, or other supporting structure such that the beam spread lens 160 can be positioned above the reflector 155. In yet another embodiment, the beam spread lens 160 can be formed from multiple beam spread lens sections, which can be connected to one another physically, electrically or optically. By way of an example, this can be achieved using bridge connectors, wires, or any suitable electrical connection method with respect to any electrical connection; snap-fit, adherence, or any suitable physical connection method to connect the multiple reflector sections with respect to any physical connection; optical bridge, connection tunnels, or any suitable optical connection method with respect to any optical connection. In one embodiment, the beam spread lens 160 can have concave, convex or any shaped light spreading surface that is optimized for spreading the light beam emitted from the LEDs 145. It is understood that a person skilled in the art can readily determine the optimal spread pattern for spreading the light beam emitted from the LEDs 145.

In one embodiment, the reflector 155 and the beam spread lens 160 can, individually or in combination, be constructed out of a molded glass, a highly optically optimized polymer, or another type of optically sufficient material. According to the yet another embodiment, the bulb cover 165 can be further make connect with the heat dissipating structure 120 and can further enclose the heat transferring structure 130, the LED support plate 135, the LEDs 145, the LED circuit board 140, the plurality of LED lens/dust caps 150, the reflector 155 or the beam spread lens 150.

The above-described examples have been described in order to allow easy understanding of the invention and do not limit the invention. On the contrary, the invention is intended to cover various modifications and equivalent arrangements, whose scope is to be accorded the broadest interpretation so as to encompass all such modifications and equivalent structure as is permitted under the law.

What is claimed is:

1. An LED-based lamp for use in a standard light fixture comprising:
a contact base having a connector for physical connection to a standard light fixture;
at least one LED;
an LED support plate thermally coupled to the at least one LED, wherein the LED support plate is configured to conduct heat generated by the at least one LED and to dissipate a first portion of the heat generated by the at least one LED;
a heat dissipating structure configured to dissipate a second portion of the heat generated by the at least one LED to the ambient air; and
a heat transferring structure thermally coupling the LED support plate to the heat dissipating structure, wherein the heat transferring structure distributes heat dissipation between the LED support plate and the heat dissipating structure.

2. The LED-based lamp of claim 1 further comprising a bulb cover, wherein the bulb cover encloses the LED support plate and the at least one LED and is configured to dissipate heat from the LED support plate to the ambient air.

3. The LED-based lamp of claim 2 wherein a power density of the bulb cover is less than a power density of the LED support plate.

4. The LED-based lamp of claim 1 further comprising a circuit board, wherein:
the at least one LED is mounted to the circuit board; and
the circuit board is supported by the LED support plate and provides a heat transfer path between the at least one LED and the LED support plate.

5. The LED-based lamp of claim 1 wherein the heat transferring structure is configured to distribute approximately 85% of the heat generated by the at least one LED to the heat dissipating structure.

6. The LED-based lamp of claim 1 wherein:
the heat transferring structure has a first end opposing a second end; and
the first end is connected in thermally conductive relation to the heat dissipating structure and the second end is connected in thermally conductive relation to the LED support plate.

7. The LED-based lamp of claim 6 wherein the heat transferring structure and the heat dissipating structure are integral.

8. The LED-based lamp of claim of claim 6 wherein the heat transferring structure is hollow.

9. The LED-based lamp of claim 8 wherein the heat transferring structure is a substantially cylindrical tube with an inner radius, and outer radius, a height and a wall thickness defined by a difference between the outer radius and inner radius.

10. The LED-based lamp of claim 9 wherein the inner and outer radii vary along the height of the cylinder.

11. The LED-based lamp of claim 1 wherein the connector is configured for electrical connection to a standard light fixture, further comprising:
electronics electrically connected to the connector, wherein the electronics include a power conversion circuit configured to convert an input power from the light fixture to an output power suitable for powering the at least one LED.

12. The LED-based lamp of claim 11, wherein:
the heat dissipating structure defines a cavity housing at least a portion of the electronics; and
the heat dissipating structure further defines a plurality of apertures to provide a convective heat transfer path from the at least a portion of the electronics to the ambient air.

13. An LED-based lamp for use in a standard light fixture comprising:
a contact base having a connector for physical connection to a standard light fixture;
at least one LED oriented to project light in a first direction along a vertical axis of the LED-based lamp;
a reflector positioned adjacent to the at least one LED in the first direction and configured to diffuse the light from the at least one LED such that a majority portion of the light is directed in a second direction away from the first direction; and
a bulb cover enclosing the at least one LED and the reflector.

14. The LED-based lamp of claim 13 wherein the reflector includes a reflector surface to direct the majority portion of the light in the second direction at an angle between 90° and 150° from the vertical axis of the LED-based lamp.

15. The LED-based lamp of claim 14 wherein the reflector is surface is conical.

16. The LED-based lamp of claim 14 wherein the reflector surface is arcuate.

17. The LED-based lamp of claim 13 wherein the reflector defines an aperture to direct less than a majority portion of the light in the first direction.

18. The LED-based lamp of claim 17, further comprising an LED lens positioned adjacent to the reflector aperture in the first direction and configured to spread the less than a majority portion of the light in the first direction at an angle between 0° and 90° from the vertical axis of the LED-based lamp.

19. The LED-based lamp of claim 13 wherein the LED is configured to provide luminosity similar to a conventional incandescent light bulb.

20. An LED-based lamp for use in a standard light fixture comprising:
a contact base having a connector for physical connection to a standard light fixture;
at least one LED configured to provide luminosity similar to a conventional incandescent light bulb;
an LED support plate composed of a thermally conductive material and configured to dissipate a first portion of the heat generated by the at least one LED;
a bulb cover enclosing the at least one LED and the LED support plate such that the first portion of the heat generated by the at least one LED is transferred to the bulb cover by radiation and convection for dissipation to the ambient air;
a heat dissipating structure composed of a thermally conductive material and configured to dissipate a second portion of the heat generated by the at least one LED to the ambient air;
a heat transferring structure composed of a thermally conductive material connecting the LED support plate to the heat dissipating structure in thermally conductive relation, wherein the heat transferring structure distributes heat dissipation between the LED support plate and the heat dissipating structure to maintain the heat dissipating structure and an outer surface of the bulb cover at a temperature below 70° C.
